(19) United States
(12) Patent Application Publication
(10) Pub. No.: US 2006/0126572 A1
(43) Pub. Date: Jun. 15, 2006

(54) Transmission timing control of uplink channel signal of a mobile station

(75) Inventor: Hiroyasu Mutou, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/302,361

(22) Filed: Dec. 14, 2005

(30) Foreign Application Priority Data
Dec. 14, 2004 (JP) 2004-360965

(51) Int. Cl. H04B 7/216; H04Q 7/00

(52) U.S. Cl. 370/335; 370/331; 370/342

(57) ABSTRACT

A base station in a CDMA radio communication system selects the path having the highest level from among paths that occur when uplink channel signals are being received from a mobile station at a plurality of sectors, compares the position of the selected path with the position of a reference path, and generates timing control information based on the results of the comparison. The base station inserts the timing control information into a downlink channel signal and transmits it to the mobile station. The mobile station alters the transmission timing of uplink channel signal in accordance with the timing control signal contained in the downlink channel signal from the base station.

### BACKGROUND OF THE INVENTION

1. Field of the Invention

The present invention relates to a CDMA (Code Division Multiple Access) radio communication system and a base station, and more particularly to a radio communication system and base station for receiving uplink channel signals from mobile stations in a plurality of sectors.

2. Description of the Related Art

In CDMA radio communication systems of prior art, a base station controls the transmission timing of uplink channel signals from a plurality of mobile stations so that it can maintain orthogonality between uplink channel signals from this plurality of mobile stations. For example, as disclosed in JP-A-1998-13918, a base station detects the phase differences between orthogonal codes of uplink channel signals from a plurality of mobile stations and reports timing control information to the associated mobile stations according to the detection results. The mobile stations then change the transmission timing of the uplink channel signals in accordance with the timing control information that has been reported from the base station.

In a CDMA radio communication system, the service area of a base station is divided between a plurality of sectors, and the base station realizes communication with mobile stations by way of antennas that are established in each of the sectors.

In FIG. 1, for example, base station (BS) 101 is of a three-sector configuration in which the service area is divided into three sectors A˜C, and base station (BS) 101 realizes communication with n mobile stations 100-1˜100-n by way of sectors A˜C.

FIG. 2 shows an example of the configuration of a base station in a radio communication system of the prior art. The base station of this example of the prior art is of a three-sector configuration comprising sectors A˜C as shown in FIG. 1, and has a circuit for each sector as shown in FIG. 2. In FIG. 2, only the circuits relating to sector A are shown, and the circuits relating to sectors B and C have been omitted.

Referring to FIG. 2, the base station of this example of the prior art includes: receiver (RX) 11a, correlators 12a-1˜12a-n, demodulators (DEM) 13-1˜13-n, timing control information generation unit 14, channel coding units 15-1˜15-n, modulators (MOD) 16-1˜16-n, synthesizer 17a, and transmitter (TX) 18a.

When an uplink channel signal of sector A from mobile station 100-1 is received at receiver 11a, correlator 12a-1 that is associated with mobile station 100-1 finds the correlation with the orthogonal code that was assigned to mobile station 100-1, and further, the orthogonal code that was generated by the base station. Correlator 12a-1 thus detects the phase difference between the orthogonal code that has been assigned to mobile station 100-1 and the orthogonal code of the uplink channel signal that was received at receiver 11a. At the same time, correlator 12a-1 despreads the uplink channel signal that was received at receiver 11a to generate a baseband signal. Demodulator 13-1 demodulates the baseband signal that was generated in correlator 12a-1 to obtain uplink data 1.

The phase difference that was detected at correlator 12a-1 is reported to timing control information generation unit 14. Timing control information generation unit 14 generates timing control information for mobile station 100-11 based on the phase difference that was reported from correlator 12a-1. The timing control information is delivered to channel coding unit 15-1 that is associated with mobile station 100-1 with which transmitter 18a communicates.

Channel coding unit 15-1 inserts the timing control information supplied from timing control information generation unit 14 into downlink data 1, and modulator 16-1 modulates downlink data 1 into which the timing control information has been inserted to generate the modulated signal that is sent to sector A.

Synthesizer 17a combines the modulated signal generated by modulator 16-1 with the modulated signals generated by the other modulators 16-2˜16-n, and transmitter 18a transmits the signal synthesized at synthesizer 17a to mobile station 100-1 from sector A as a downlink channel signal.

In the base station of this example of the prior art, processing is carried out by the same procedures as described above for uplink channel signals received in receiver 11a from mobile stations 100-2˜100-n.

Mobile stations 100-1˜100-n alter the transmission timing and transmit the uplink channel signal in accordance with the timing control information contained in the downlink channel signal from the base station.

When detecting the phase differences between the orthogonal codes of uplink channel signals in correlators 12a-1˜12a-n, a plurality of paths may occur due to delay dispersion of the uplink channel signals. As is also disclosed in JP-A-1998-13918, selecting the path having the highest level in such cases maintains the orthogonality of the uplink channel signal for at least the path having the highest level.

In addition, mobile stations 100-1˜100-n also implement communication with the base station in which radio links are simultaneously connected with two or more sectors of a base station and soft handover between two or more sectors is carried out. Methods of soft handover are disclosed in JP-A-1997-261162 and JP-A-2001-359138. In addition, the methods disclosed in these documents are directed towards shortening the time interval required for switching base stations.

However, the base station of FIG. 2 is not configured to allow handling of soft handover between sectors. For example, when mobile station 100-1 moves and implements soft handover between sectors A and B in FIG. 1, the base station receives the uplink channel signal from mobile station 100-1 at sector A and sector B and combines the two. However, due to the dispersion of delay of the uplink channel signal from mobile station 100-1, the occurrence of differences in the propagation environment at sector A and sector B can cause a discrepancy between the phase difference detected at sector A and the phase difference detected at sector B for the uplink channel signal from mobile station 100-1 in the base station.

In such cases, two types of timing control information are obtained in the base station as the timing control information that is to be reported to mobile station 100-1: the timing control information that matches the reception timing of the uplink channel signal of sector A, and the timing signal that matches the reception timing of the uplink channel signal of sector B. Since only one type of timing control information is actually transmitted to mobile station 100-1, the orthogonality of the uplink channel signal cannot be maintained for both sector A and B.

For example, as shown in FIG. 3, a case is considered in which mobile stations MS1 and MS2 communicate with the base station by way of sector A and mobile stations MS4 and MS5 communicate with the base station by way of sector B, and mobile station MS3 communicates with the base station by performing a soft handover between sectors A and B. In this case, it is assumed that the transmission timing of the uplink channel signals of mobile stations MS1˜MS5 is not controlled, and that mobile stations MS1˜MS5 transmit uplink channel signals to the base station at the same transmission timing. In this case, at the base station, the reception timings of the uplink channel signals that are received at sector A from mobile stations MS1˜MS3 does not coincide, and in addition, the reception timings of the uplink channel signals that are received from mobile stations MS3˜MS5 at sector B also do not coincide.

However, as shown in FIG. 4, the base station transmits timing control information to mobile stations MS1˜MS5, and mobile stations MS1˜MS5 alter the transmission timing of the uplink channel signals based on the timing control information, whereby the reception timings of the uplink channel signals that are received from mobile stations MS1˜MS3 at sector A are made to coincide at the base station, and the reception timings of the uplink channel signals that are received from mobile stations MS4 and MS5 at sector B are made to coincide.

However, the base station transmits timing control information, that is based on the reception timing of the uplink channel signal of sector A, to mobile station MS3 that is performing soft handover between sectors A and B. Thus, even after transmission timing control, the reception timing of the uplink channel signal from mobile station MS3 at sector B cannot be made to coincide with the reception timing of the uplink channel signal from other mobile stations MS4 and MS5.

### SUMMARY OF THE INVENTION

It is an object of the present invention to provide a radio communication system and base station in which an appropriate timing control signal can be generated when a particular mobile station is performing soft handover between sectors even when the phase differences that are detected in each sector do not match.

According to the present invention, a CDMA radio communication system is provided that includes: mobile stations for performing soft handover between a plurality of sectors to transmit uplink channel signals; and a base station for transmitting, to the mobile stations, timing control information to control the transmission timing of uplink channel signals.

The base station is composed of: a plurality of receivers each associated with each of the plurality of sectors; a plurality of correlators each associated with each of the plurality of sectors; a timing control information generation unit; and a plurality of transmitters each associated with each of the plurality of sectors.

Each of the plurality of receivers receives from the associated sector uplink channel signals from mobile stations. Each of the plurality of correlators detects the phase difference between the orthogonal code of the uplink channel signal, that is received at a receiver from the associated sector, and the orthogonal code assigned to a mobile station. Based on the phase differences that have been detected at each of the plurality of correlators, the timing control information generation unit selects the path having the highest level from among the paths that occur when uplink channel signals are being received at each of the plurality of sectors, compares the position of the selected path with the position of a reference path, and generates timing control information based on the results of this comparison. Each of the plurality of transmitters transmits from the associated sector to the mobile station a downlink channel signal that contains the timing control information that has been generated in the timing control information generation unit.

Another timing control information generation unit, based on the phase differences that have been detected at each of the plurality of correlators, selects the path having the highest level from among the paths that occur in common when uplink channel signals are received at each of the plurality of sectors, compares the position of the selected path with the position of a reference path, and generates timing control information based on the results of this comparison.

Yet another timing control information generation unit performs the following operations: selects the sector to which a downlink channel signal is being transmitted from among the plurality of sectors; based on the phase differences that have been detected by the correlator that is associated with the sector that has been selected from among the plurality of correlators, selects the path having the highest level from among the paths that occur when uplink channel signals are being received at the selected sector; compares the position of the selected path with the position of a reference path; and generates timing control information based on the results of this comparison.

According to the present invention, a base station selects the path having the highest level from among paths that occur in a plurality of sectors, and generates timing control information by comparing the position of the selected path with the position of a reference path.

Accordingly, even when the phase differences that have been detected at each of the sectors do not match, a single phase difference can be determined according to the position of the selected path and the position of a reference path, whereby an appropriate timing control signal can be generated, and intersymbol interference between channels can be suppressed.

The above and other objects, features, and advantages of the present invention will become apparent from the following description with reference to the accompanying drawings, which illustrate examples of the present invention.

### BRIEF DESCRIPTION OF THE DRAWINGS

FIG. 1 shows the overall configuration of a radio communication system;

FIG. 2 is a block diagram showing an example of the configuration of the base station in a radio communication system of the prior art;

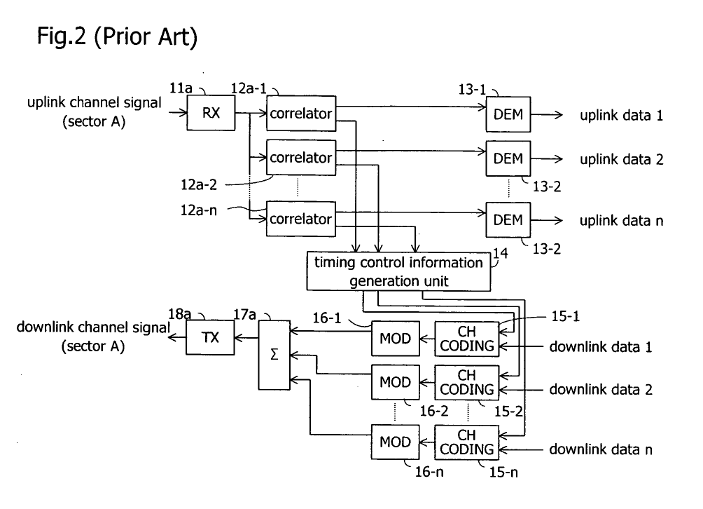

FIG. 3 shows the reception timing of a base station and the transmission timing of each mobile station when transmission timing control is not implemented;

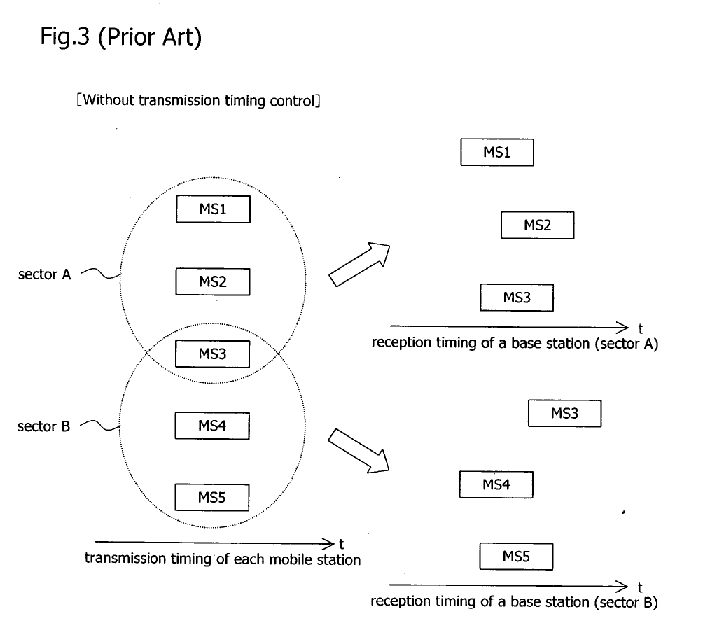

FIG. 4 shows the reception timing of a base station and the transmission timing of each mobile station when transmission timing control is implemented according to the prior art;

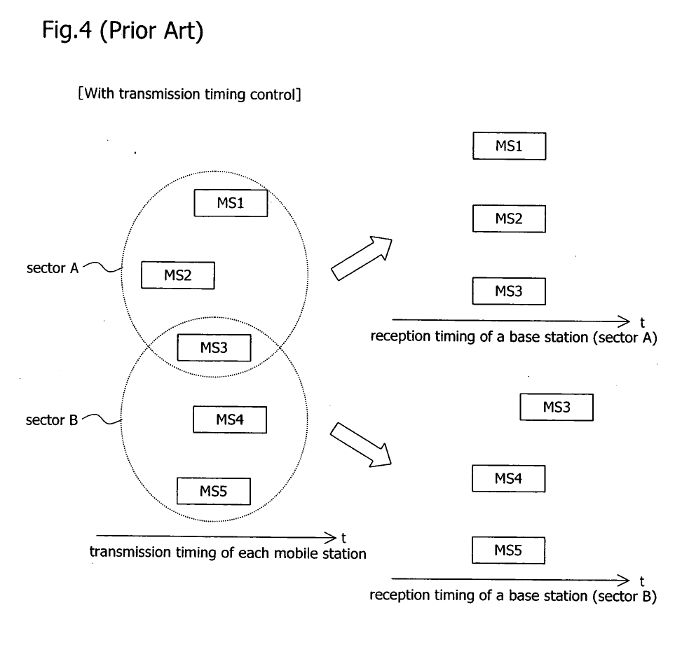

FIG. 5 is a block diagram showing the configuration of a base station in the radio communication system according to an embodiment of the present invention;

FIG. 6 is a flow chart explaining an example of the method of generating timing control information by means of the timing control information generation unit shown in FIG. 5;

FIG. 7 is a view explaining the phases used in the generation of timing control information in FIG. 6;

FIG. 8 is a flow chart explaining another example of the method of generating timing control information by means of the timing control information generation unit shown in FIG. 5;

FIG. 9 is a view explaining the phases used in the generation of timing control information in FIG. 8;

FIG. 10 is a flow chart explaining yet another example of the method of generating timing control information by means of the timing control information generation unit shown in FIG. 5; and

FIG. 11 is a view explaining the phases used in the generation of timing control information in FIG. 10.

### DETAILED DESCRIPTION OF THE PREFERRED EMBODIMENTS

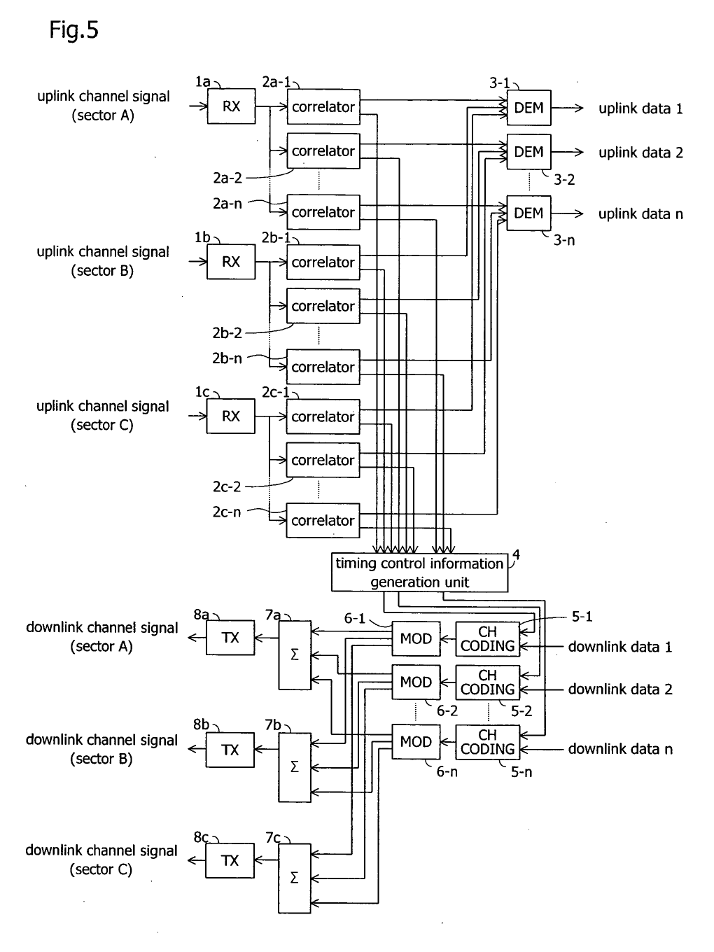

FIG. 5 shows the configuration of a base station in a radio communication system according to an embodiment of the present invention.

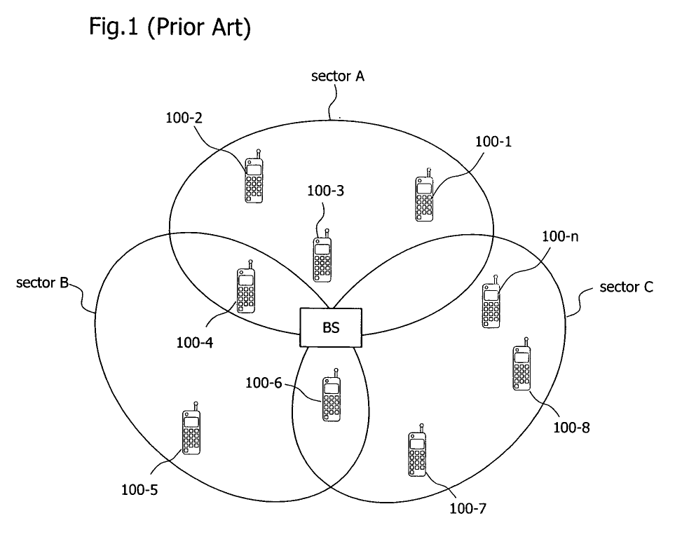

As shown in FIG. 1, a base station according to the present embodiment is described as a device that is of a three-sector configuration that comprise sectors A˜C and as a device that realizes communication with n mobile stations 100-1˜100-n by way of sectors A˜C.

In addition, the base station according to the present embodiment is described as a device that, when communicating with a mobile station that is performing soft handover between sectors, receives uplink channel signals from all associated sectors, and further, transmits a downlink channel signal from any one of the associated sectors.

Referring to FIG. 5, the base station according to the present invention includes: receivers (RX) 1a˜1c; correlators 2a-1˜2a-n, 2b-1˜2b-n, and 2c-1˜2c-n; demodulators (DEM) 3-1˜3-n; timing control information generation unit 4; channel coding units 5-1˜5-n; modulators (MOD) 6-1˜6-n; synthesizers 7a˜7c; and transmitters (TX) 8a˜8c.

When an uplink channel signal of sector A from mobile station 100-1 is received at receiver 1a, correlator 2a-1 that is associated with mobile station 100-1 finds the correlation with the orthogonal code assigned to mobile station 100-1, and moreover, the orthogonal code generated at the base station. Correlator 2a-1 thus detects the phase difference between the orthogonal code assigned to mobile station 100-1 and the orthogonal code of the uplink channel signal of sector A that has been received at receiver 1a. At the same time, correlator 2a-1 despreads the uplink channel signal of sector A that has been received at receiver 1a to generate a baseband signal.

Similarly, when an uplink channel signal of sector B from mobile station 100-1 is received at receiver 1b, correlator 2b-1 that is associated with mobile station 100-1 finds the correlation with the orthogonal code assigned to mobile station 100-1, and moreover, the orthogonal code generated at the base station, whereby correlator 2b-1 detects the phase difference between the orthogonal code assigned to mobile station 100-1 and the orthogonal code of the uplink channel signal of sector B received by receiver 1b. At the same time, correlator 2b-1 despreads the uplink channel signal of sector B that was received at receiver 1b to generate a baseband signal. In addition, the detection of phase difference and generation of a baseband signal is carried out for the uplink channel signal of sector C by the same procedures as described above.

When mobile station 100-1 is performing soft handover between sectors, the uplink channel signal is received from two or more sectors, and two or more baseband signals are therefore generated. When mobile station 100-1 is not performing soft handover between sectors, the uplink channel signal is received from only one sector and only one baseband signal is generated.

When the uplink channel signals from each of sectors A, B, and C undergo the despreading process in correlators 2a-1, 2b-1, 2c-1 and baseband signals are generated, demodulator 3-1 combines and demodulates each of the baseband signals to obtain uplink data 1.

In addition, when the uplink channel signal of sector A from mobile station 100-n is received at receiver 1a, correlator 2a-n that is associated with mobile station 100-n finds the correlation with the orthogonal code assigned to mobile station 100-n, and moreover, the orthogonal code generated at the base station, whereby correlator 2a-n detects the phase difference between the orthogonal code assigned to mobile station 100-n and the orthogonal code of the uplink channel signal of sector A received at receiver 1a. At the same time, correlator 2a-n despreads the uplink channel signal of sector A received at receiver 1a to generate a baseband signal.

Similarly, when the uplink channel signal of sector B from mobile station 100-n is received at receiver 1b, correlator 2b-n that is associated with mobile station 100-n finds the correlation with the orthogonal code assigned to mobile station 100-n, and moreover, the orthogonal code generated at the base station, whereby correlator 2b-n detects the phase difference between the orthogonal code assigned to mobile station 100-n and the orthogonal code of the uplink channel signal of sector B received at receiver 1b. At the same time, correlator 2b-n despreads the uplink channel signal of sector B received at receiver 1b to generate a baseband signal. In addition, the detection of phase difference and the generation of a baseband signal are carried out for the uplink channel signal of sector C by the same procedures as described above.

When the uplink channel signals from each of sectors A, B, and C undergo despreading and baseband signals are respectively generated in each of correlators 2a-n, 2b-n, and 2c-n, demodulator 3-n combines and demodulates each of the baseband signals to obtain uplink data n.

The phase difference obtained from the uplink channel signal of sector A, the phase difference obtained from the uplink channel signal of sector B, and the phase difference obtained from the uplink channel signal of sector C for mobile station 100-1 are reported to timing control information generation unit 4. Timing control information generation unit 4 generates timing control information for mobile station 100-1 based on the reported phase differences. The timing control information is delivered to channel coding unit 5-1 that is associated with mobile station 100-1 with which transmitters 8a˜8c are communicating. Channel coding unit 5-1 inserts the timing control information supplied from timing control information generation unit 4 into downlink data 1. Modulator 6-1 modulates downlink data 1 into which the timing control information has been inserted to generate a modulated signal that is sent to any one of sectors A˜C.

In addition, timing control information generation unit 4 also generates timing control information for mobile station 100-n by the same procedures. The timing control information is delivered to channel coding unit 5-n that is associated with mobile station 100-n with which transmitters 8a˜8c are communicating. Channel coding unit 5-n inserts the timing control information supplied from timing control information generation unit 4 into downlink data n. Modulator 6-n modulates downlink data n into which the timing control information has been inserted to generate a modulated signal that is sent to any one of sectors A˜C.

The downlink channel signal for mobile station 100-1 is sent to any one of the associated sectors when mobile station 100-1 is performing soft handover between sectors. In addition, the downlink channel signal for mobile station 100-n is also sent to any one of the associated sectors when mobile station 100-n is performing soft handover between sectors.

Synthesizer 7a combines the modulated signals of the channels sent to each of mobile stations 100-1˜100-n from sector A, and transmitter 8a transmits the signal that has been combined in synthesizer 7a as the downlink channel signal to each of mobile stations 100-1˜100-n from sector A.

Synthesizer 7b combines the modulated signals of the channels sent to each of mobile stations 100-1˜100-n from sector B, and transmitter 8b transmits the signal that has been combined in synthesizer 7b as the downlink channel signal to each of the mobile stations 100-1˜100-n from sector B.

Synthesizer 7c combines the modulated signals of the channels that are sent to each of mobile stations 100-1˜100-n from sector C, and transmitter 8c transmits the signal that has been combined in synthesizer 7c as a downlink channel signal to each of the mobile stations 100-1˜100-n from sector C.

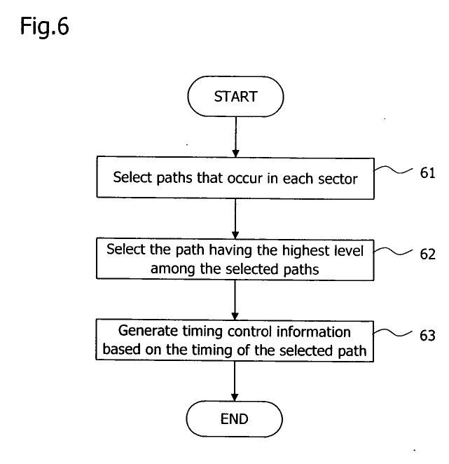

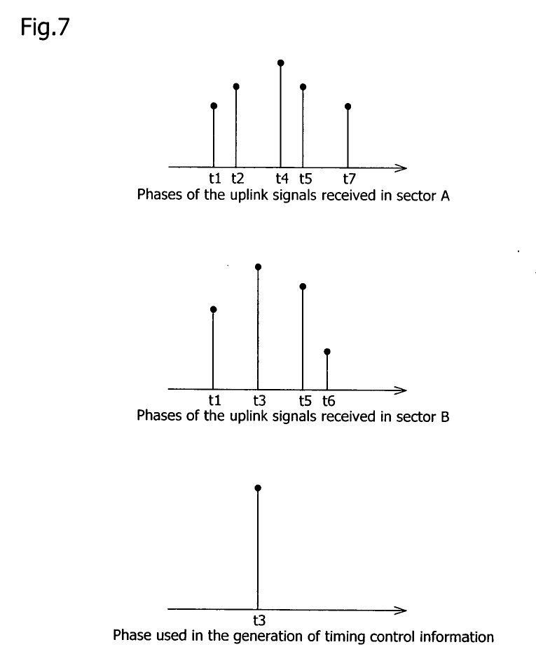

The following explanation regards an example of the method of generating timing control information by means of timing control information generation unit 4 with reference to FIG. 6 and FIG. 7.

In FIGS. 6 and 7, timing control information generation unit 4 generates timing control information based on the position of the path having the highest level from among the paths that occur in each of the sectors. In this case, it is assumed that mobile station 100-1 is performing soft handover between sectors A and B.

In Step 61, timing control information generation unit 4 first selects paths t1, t2, t4, t5, and t7 that occur when an uplink channel signal is received at sector A and paths t1, t3, t5, and t6 that occur when an uplink channel signal is received at sector B based on the phase differences that have been reported from correlators 2a-1 and 2b-1. In Step 62, timing control information generation unit 4 next selects path t3 of sector B that has the highest level from among the paths selected in Step 61. Then, in Step 63, timing control information generation unit 4 compares the position of path t3 selected in Step 62 with the position of a reference path, and generates timing control information such that the result of this comparison approaches 0.

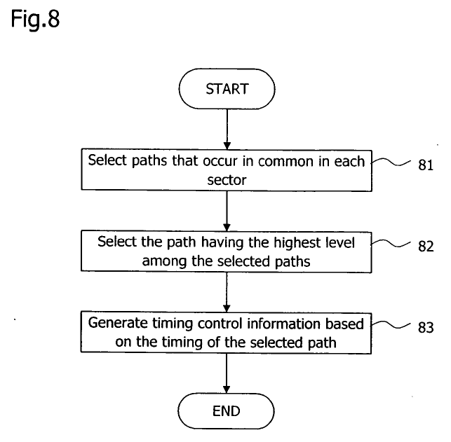

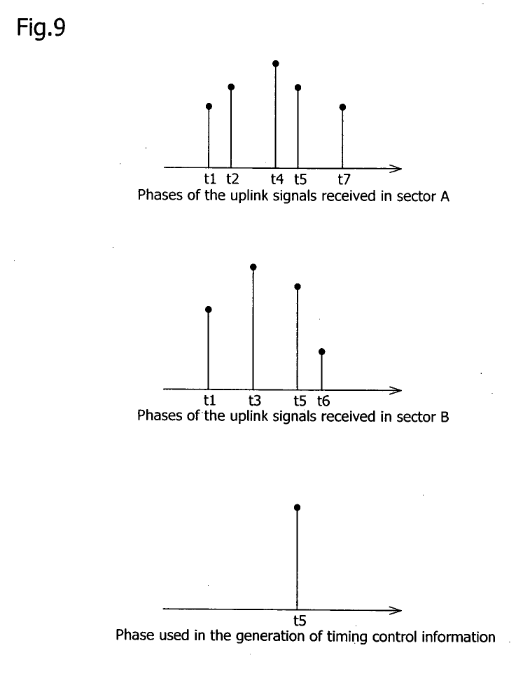

The explanation next regards another example of the method of generating timing control information by means of timing control information generation unit 4 with reference to FIGS. 8 and 9.

In FIGS. 8 and 9, timing control information generation unit 4 generates timing control information based on the position of the path having the highest level from among the paths that occur in common in each sector. It is here assumed that mobile station 100-1 is performing soft handover between sectors A and B.

In Step 81, timing control information generation unit 4 first selects paths t1 and t5 that occur in common when an uplink channel signal is received at sectors A and B based on the phase differences that were reported from correlators 2a-1 and 2b-1. In Step 82, timing control information generation unit 4 next selects path t5 that has the highest level from among the paths selected in Step 81. In Step 83, timing control information generation unit 4 then compares the position of path t5 that was selected in Step 82 and the position of a reference path, and generates timing control information such that the result of this comparison approaches 0.

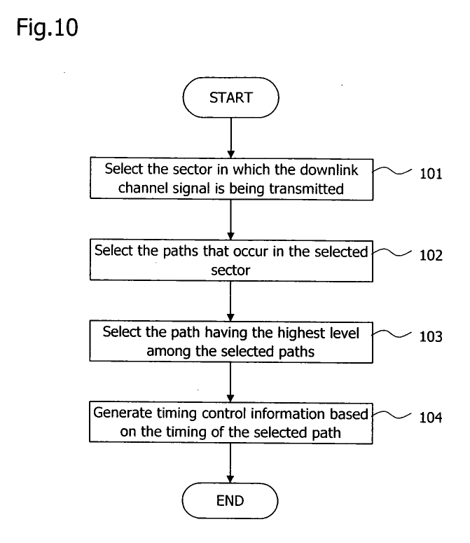

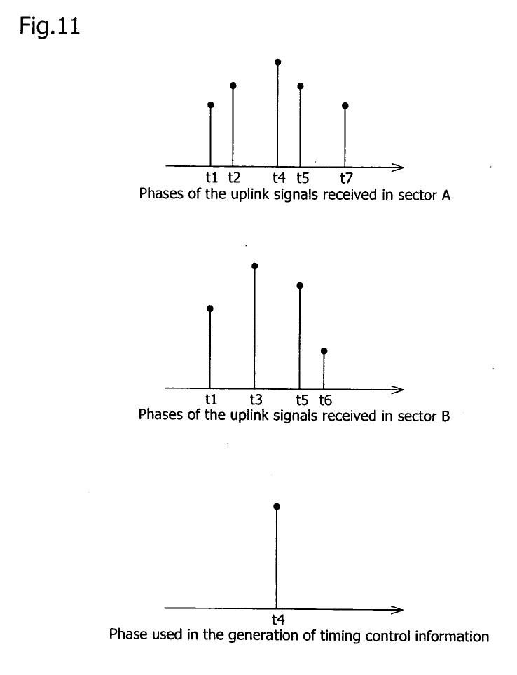

The explanation next regards yet another example of the method of generating timing control information by means of timing control information generation unit 4 with reference to FIGS. 10 and 11.

In FIGS. 10 and 11, timing control information generation unit 4 generates timing control information based on the position of the path having the highest level from among the paths that occur in the sector that is transmitting a downlink channel signal. It is here assumed that mobile station 100-1 is performing a soft handover between sectors A and B and that a downlink channel signal is being transmitted from sector A to mobile station 100-1.

In Step 101, timing control information generation unit 4 first selects sector A that is transmitting a downlink channel signal. In Step 102, timing control information generation unit 4 next, based on the phase differences reported from correlator 2a-1, selects paths t1, t2, t4, t5, and t7 that occur when an uplink channel signal is being received at sector A. In Step 103, timing control information generation unit 4 next selects path t4 that has the highest level from among the paths selected in Step 102. In Step 104, timing control information generation unit 4 then compares the position of path t4 selected in Step 103 and the position of a reference path, and generates timing control information such that the result of the comparison approaches 0.

While preferred embodiments of the present invention have been described using specific terms, such description is for illustrative purposes only, and it is to be understood that changes and variations may be made without departing from the spirit or scope of the following claims.

What is claimed is:

1. A CDMA radio communication system, comprising:
mobile stations for performing soft handover between a plurality of sectors to transmit uplink channel signals, and
a base station for transmitting, to said mobile stations, timing control information to control the transmission timing of uplink channel signals;
wherein said base station includes:
a plurality of receivers each associated with each of said plurality of sectors, each of said receivers receiving, from the associated sector, uplink channel signals from each of said mobile stations;
a plurality of correlators each associated with each of said plurality of sectors, each of said correlators detecting the phase difference between an orthogonal code of an uplink channel signal received from an associated sector at said receiver and an orthogonal code that has been assigned to said mobile station;
a timing control information generation unit for, based on the phase differences detected in each of said plurality of correlators, selecting the path having the highest level from among paths that occur when uplink channel signals are being received at each of said plurality of sectors, comparing the position of the selected path with the position of a reference path, and generating said timing control information based on the results of the comparison; and
a plurality of transmitters each associated with each of said plurality of sectors, each of said transmitters transmitting, to said mobile stations from the associated sectors, downlink channel signals that include timing control information generated in said timing control information generation unit.

2. A CDMA radio communication system, comprising:
mobile stations for performing soft handover between a plurality of sectors to transmit uplink channel signals, and
a base station for transmitting, to said mobile stations, timing control information to control the transmission timing of uplink channel signals;
wherein said base station includes:
a plurality of receivers each associated with each of said plurality of sectors, each of said receivers receiving, from the associated sector, uplink channel signals from each of said mobile stations;
a plurality of correlators each associated with each of said plurality of sectors, each of said correlators detecting the phase difference between an orthogonal code of an uplink channel signal received from an associated sector at said receiver and an orthogonal code that has been assigned to said mobile station;
a timing control information generation unit for, based on the phase differences that have been detected in each of said plurality of correlators, selecting the path having the highest level from among paths that occur in common when uplink channel signals are being received at each of said plurality of sectors, comparing the position of the selected path with the position of a reference path, and generating said timing control information based on the results of the comparison; and
a plurality of transmitters each associated with each of said plurality of sectors, each of said transmitters transmitting to said mobile stations from the associated sectors downlink channel signals that include timing control information generated in said timing control information generation unit.

3. A CDMA radio communication system, comprising:
mobile stations for performing soft handover between a plurality of sectors to transmit uplink channel signals, and
a base station for transmitting, to said mobile stations, timing control information to control the transmission timing of uplink channel signals;
wherein said base station includes:
a plurality of receivers each associated with each of said plurality of sectors, each of said receivers receiving, from the associated sector, uplink channel signals from each of said mobile stations;
a plurality of correlators each associated with each of said plurality of sectors, each of said correlators detecting the phase difference between an orthogonal code of an uplink channel signal received from an associated sector at said receiver and an orthogonal code that has been assigned to said mobile station;
a timing control information generation unit for selecting, from among said plurality of sectors, a sector in which the downlink channel signal is being transmitted, and, based on the phase difference detected in the correlator that is associated with the selected sector from among said plurality of correlators, selecting the path having the highest level from among paths that occur when uplink channel signals are being received at the selected sector, comparing the position of the selected path with the position of a reference path, and generating said timing control information based on the results of the comparison; and
a plurality of transmitters each associated with each of said plurality of sectors, each of said transmitters transmitting to said mobile stations from the associated sectors downlink channel signals that include timing control information generated in said timing control information generation unit.

4. A base station for transmitting, to mobile stations that perform soft handover between a plurality of sectors to transmit uplink channel signals, timing control information to control the transmission timing of uplink channel signals, said base station comprising:
a plurality of receivers each associated with each of said plurality of sectors, each of said receivers receiving, from the associated sector, uplink channel signals from said mobile stations;
a plurality of correlators each associated with each of said plurality of sectors, each of said correlators detecting the phase difference between an orthogonal code of an uplink channel signal received from the associated sector at said receiver and an orthogonal code that has been assigned to said mobile stations;
a timing control information generation unit for, based on the phase differences detected at each of said plurality of correlators, selecting the path having the highest level from among paths that occur when uplink channel signals are being received at each of said plurality of sectors, comparing the position of the selected path with the position of a reference path, and generating said timing control information based on the results of the comparison; and
a plurality of transmitters each associated with each of said plurality of sectors, each of said transmitters transmitting, to said mobile stations from the associated sector, a downlink channel signal that contains timing control information generated in said timing control information generation unit.

5. A base station for transmitting, to mobile stations that perform soft handover between a plurality of sectors to transmit uplink channel signals, timing control information to control the transmission timing of uplink channel signals, said base station comprising:
a plurality of receivers each associated with each of said plurality of sectors, each of said receivers receiving, from the associated sector, uplink channel signals from said mobile stations;
a plurality of correlators each associated with each of said plurality of sectors, each of said correlators detecting the phase difference between an orthogonal code of an uplink channel signal received from the associated sector at said receiver and an orthogonal code that has been assigned to said mobile stations;
a timing control information generation unit for, based on the phase differences detected at each of said plurality of correlators, selecting the path having the highest level from among paths that occur in common when uplink channel signals are being received at each of said plurality of sectors, comparing the position of the selected path with the position of a reference path, and generating said timing control information based on the results of the comparison; and
a plurality of transmitters each associated with each of said plurality of sectors, each of said transmitters transmitting, to said mobile stations from the associated sector, a downlink channel signal that contains timing control information generated in said timing control information generation unit.

6. A base station for transmitting, to mobile stations that perform soft handover between a plurality of sectors to transmit uplink channel signals, timing control information to control the transmission timing of uplink channel signals, said base station comprising:
a plurality of receivers each associated with each of said plurality of sectors, each of said receivers receiving, from the associated sector, uplink channel signals from said mobile stations;
a plurality of correlators each associated with each of said plurality of sectors, each of said correlators detecting the phase difference between an orthogonal code of an uplink channel signal received from the associated sector at said receiver and an orthogonal code that has been assigned to said mobile stations;
a timing control information generation unit for selecting, from among said plurality of sectors, a sector in which a downlink channel signal is being transmitted, and, based on the phase differences detected at the correlator that is associated with the selected sector from among said plurality of correlators, selecting the path having the highest level from among paths that occur when uplink channel signals are being received at the selected sector, comparing the position of the selected path with the position of a reference path, and generating said timing control information based on the results of the comparison; and
a plurality of transmitters each associated with each of said plurality of sectors, each of said transmitters transmitting, to said mobile stations from the associated sector, a downlink channel signal that contains timing control information generated in said timing control information generation unit.
